(19) United States
(12) Patent Application Publication
(10) Pub. No.: US 2024/0112633 A1
(43) Pub. Date: Apr. 4, 2024

(54) DISPLAY DEVICE

(71) Applicant: Samsung Display Co., Ltd., Yongin-si (KR)

(72) Inventors: SUNGJIN HONG, Yongin-si (KR); SUNHO KIM, Yongin-si (KR); PILSUK LEE, Yongin-si (KR); YOOMIN KO, Yongin-si (KR); Hyewon KIM, Yongin-si (KR); JUCHAN PARK, Yongin-si (KR); CHUNG SOCK CHOI, Yongin-si (KR)

(73) Assignee: Samsung Display Co., Ltd., Yongin-si (KR)

(21) Appl. No.: 18/474,442

(22) Filed: Sep. 26, 2023

(30) Foreign Application Priority Data
Sep. 27, 2022 (KR) 10-2022-0122555

(51) Int. Cl. G09G 3/3233; G09G 3/20

(52) U.S. Cl. CPC G09G 3/3233; G09G 3/2007; G09G 2300/0819; G09G 2300/0852; G09G 2300/0861; G09G 2310/08; G09G 2320/0233; G09G 2320/0257; G09G 2320/045

(57) ABSTRACT

A display device includes a display panel including a pixel, and a panel driver that drives the display panel. The pixel includes a light emitting device electrically connected to a first power line, a first transistor electrically connected to a cathode of the light emitting device and operating depending on a potential of a first node, a second transistor electrically connected between a data line and a second node, a third transistor electrically connected between a reference voltage line and the second node, a first capacitor electrically connected between the first node and the second node, a second capacitor electrically connected between a third node disposed between the first capacitor and the second node and the first power line, and a fourth transistor electrically connected between the first transistor and a compensation voltage line.

### CROSS-REFERENCE TO RELATED APPLICATION(S)

This application claims priority to and benefits of Korean Patent Application No. 10-2022-0122555 under 35 U.S.C. § 119, filed on Sep. 27, 2022 in the Korean Intellectual Property Office, the entire contents of which are incorporated herein by reference.

### BACKGROUND

### 1. Technical Field

Embodiments of the disclosure relate to a display device with improved resolution.

### 2. Description of the Related Art

Multimedia electronic devices such as a television, a mobile phone, a tablet computer, a navigation system, a game console, and the like may include a display panel for displaying an image.

The display panel may include a light emitting device and a circuit for driving the light emitting device. The light emitting devices included in the display panel may emit light according to a voltage applied from a circuit and generate an image. To improve the reliability of a display panel, research on the connection of light emitting devices and circuits is being conducted.

### SUMMARY

Embodiments of the disclosure provide a display device including a pixel circuit structure that improves resolution.

According to an embodiment of the disclosure, a display device may include a display panel including a pixel, and a panel driver that drives the display panel. The pixel may include a light emitting device electrically connected to a first power line, a first transistor electrically connected to a cathode of the light emitting device and operating depending on a potential of a first node, a second transistor electrically connected between a data line and a second node, a third transistor electrically connected between a reference voltage line and the second node, a first capacitor electrically connected between the first node and the second node, a second capacitor electrically connected between a third node disposed between the first capacitor and the second node and the first power line, and a fourth transistor electrically connected between the first transistor and a compensation voltage line.

According to an embodiment, the first power line may be directly connected to an anode of the light emitting device.

According to an embodiment, the first transistor may be an N-type transistor.

According to an embodiment, the first transistor may include a first electrode electrically connected to the light emitting device, a second electrode electrically connected to a second power line, and a gate electrically connected to the first node, and the fourth transistor may be electrically connected to the first electrode.

According to an embodiment, the fourth transistor may include a first electrode electrically connected to the compensation voltage line, a gate electrically connected to a compensation scan line, and a second electrode electrically connected to the first electrode of the first transistor.

According to an embodiment, the pixel may further include a first emission control transistor electrically connected between the first electrode and the cathode of the light emitting device, and a second emission control transistor electrically connected between the second electrode and the second power line.

According to an embodiment, the pixel may further include a first initialization transistor electrically connected between a first initialization voltage line and the first node, and a second initialization transistor electrically connected between a first electrode of the first emission control transistor and a second initialization voltage line.

According to an embodiment, the pixel may further include a fifth transistor electrically connected between the second electrode of the first transistor and the first node.

According to an embodiment, a gate of the fifth transistor may be electrically connected to a same compensation scan line as a gate of the fourth transistor.

According to an embodiment, the first initialization voltage line may provide a first initialization voltage and a magnitude of the first initialization voltage may be in a range of about 4V to about 20V.

According to an embodiment, the compensation voltage line may provide a compensation voltage, and a magnitude of the compensation voltage may be less than that of the first initialization voltage.

According to an embodiment, the reference voltage line may provide a reference voltage, and the reference voltage may be greater than the compensation voltage minus about 8V and equal to or less than the compensation voltage plus about 8V.

According to an embodiment, the first transistor may further include a back gate, and the back gate may be electrically connected to the compensation scan line electrically connected to the fourth transistor.

According to an embodiment, the panel driver may include a scan driver that outputs a plurality of scan signals to a plurality of scan lines, and a data driver that outputs a data signal to the data line.

According to an embodiment, the pixel may further include a first initialization transistor electrically connected between a first initialization voltage line and the first node, and a second initialization transistor electrically connected between a first electrode of the first emission control transistor and the first power line.

According to an embodiment, a data writing period in which the second transistor is turned on and a compensation period in which the fourth transistor is turned on may not overlap each other.

According to an embodiment, the compensation period may appear before the data writing period, and the fourth transistor may be turned off during the data writing period.

According to an embodiment of the disclosure, a display device may include a display panel including a pixel, and a panel driver that drives the display panel and including a scan driver electrically connected to a plurality of scan lines. The pixel may include a light emitting device including an anode electrically connected to a power line and a cathode electrically connected to a first transistor operating depending on a potential of a first node, a second transistor electrically connected between a data line and the first node, a first capacitor electrically connected between the second transistor and the first node, and an additional transistor electrically connected between the first transistor and a compensation voltage line to directly apply a compensation voltage to the first transistor.

According to an embodiment, the additional transistor may be turned on depending on a compensation scan signal applied from the scan driver, and the second transistor may be turned on depending on a data writing scan signal applied from the scan driver.

According to an embodiment, the additional transistor may be turned on before the second transistor and may be turned off during a period in which the second transistor is turned on.

### BRIEF DESCRIPTION OF THE DRAWINGS

The above and other aspects and features of the disclosure will become apparent by describing in detail embodiments thereof with reference to the accompanying drawings.

FIG. 1 is a schematic block diagram of a display device, according to an embodiment of the disclosure.

FIG. 2 is a schematic diagram of an equivalent circuit of a pixel according to an embodiment of the disclosure.

FIG. 3 is a schematic timing diagram for describing an operation of a display device, according to an embodiment of the disclosure.

FIG. 4 is a schematic diagram of an equivalent circuit of a pixel, according to an embodiment of the disclosure.

FIG. 5A is a schematic diagram of an equivalent circuit of a pixel, according to an embodiment of the disclosure.

FIG. 5B is a schematic timing diagram for describing an operation of FIG. 5A, according to an embodiment of the disclosure.

FIG. 6A is a schematic diagram of an equivalent circuit of a pixel, according to an embodiment of the disclosure.

FIG. 6B is a schematic timing diagram for describing an operation of FIG. 6A, according to an embodiment of the disclosure.

FIG. 7A is a schematic diagram of an equivalent circuit of a pixel, according to an embodiment of the disclosure.

FIG. 7B is a schematic timing diagram for describing an operation of FIG. 7A, according to an embodiment of the disclosure.

FIG. 8A is a schematic diagram of an equivalent circuit of a pixel, according to an embodiment of the disclosure.

FIG. 8B is a schematic timing diagram for describing an operation of FIG. 8A, according to an embodiment of the disclosure.

FIG. 9A is a schematic diagram of an equivalent circuit of a pixel, according to an embodiment of the disclosure.

FIG. 9B is a schematic timing diagram for describing an operation of FIG. 9A, according to an embodiment of the disclosure.

FIG. 10A is a schematic diagram of an equivalent circuit of a pixel, according to an embodiment of the disclosure.

FIG. 10B is a schematic timing diagram for describing an operation of FIG. 10A, according to an embodiment of the disclosure.

### DETAILED DESCRIPTION OF THE EMBODIMENTS

The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

It will be understood that the terms “connected to” or “coupled to” may include a physical or electrical connection or coupling.

The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art.

When an element is described as “not overlapping” or to “not overlap” another element, this may include that the elements are spaced apart from each other, offset from each other, or set aside from each other or any other suitable term as would be appreciated and understood by those of ordinary skill in the art.

Like reference numerals refer to like components. In the drawings, the thickness, ratio, and dimensions of components may be exaggerated for effectiveness of description of technical contents.

In the specification and the claims, the term “and/or” is intended to include any combination of the terms “and” and “or” for the purpose of its meaning and interpretation. For example, “A and/or B” may be understood to mean any combination including “A, B, or A and B.” The terms “and” and “or” may be used in the conjunctive or disjunctive sense and may be understood to be equivalent to “and/or.”

For the purposes of this disclosure, the phrase “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z.

The terms “first”, “second”, etc. are used to describe various components, but the components are not limited by the terms. The terms are used only to differentiate one component from another component. For example, a first component may be named as a second component, and vice versa, without departing from the spirit or scope of the disclosure. A singular form, unless otherwise stated, includes a plural form.

The terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless defined or implied otherwise, all terms (including technical and scientific terms) used herein have the same meaning as commonly understood by one of ordinary skill in the art to which this disclosure belongs. In addition, terms defined in commonly used dictionaries should be interpreted as having a meaning consistent with the meaning in the context of the related technology, and should not be interpreted as having an ideal or excessively formal meaning unless explicitly defined in the disclosure.

“About” or “approximately” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

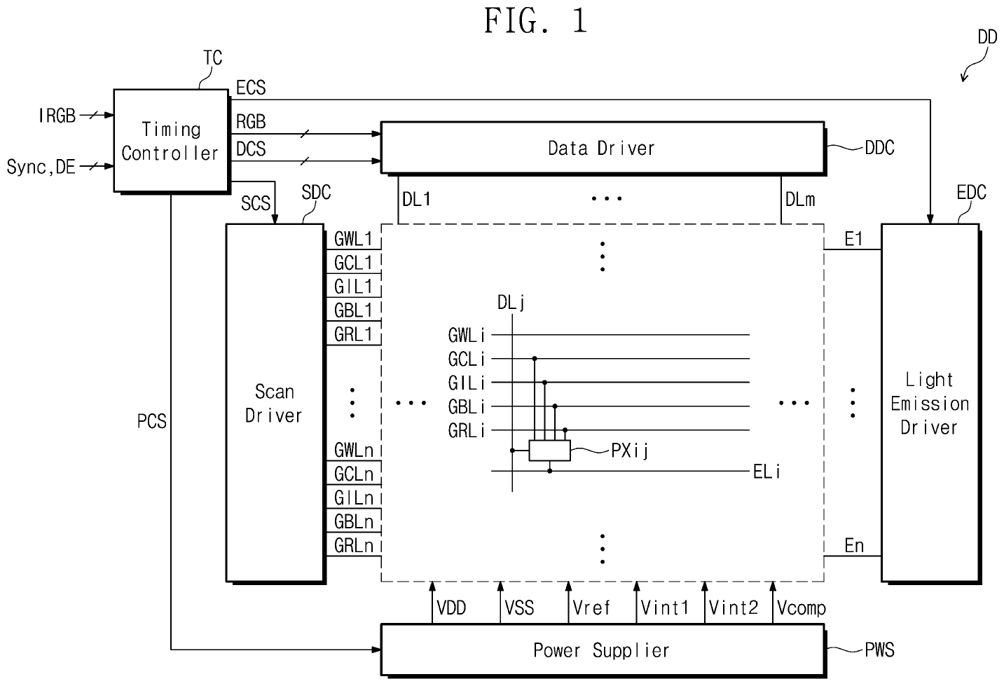

FIG. 1 is a schematic block diagram of a display device DD, according to an embodiment of the disclosure.

Referring to FIG. 1, the display device DD may include a timing controller TC, a panel driver, and a display panel DP. In an embodiment, the display panel DP is described as a light emitting display panel. The light emitting display panel may include an organic light emitting display panel or a quantum dot light emitting display panel. The panel driver may include a scan driver SDC, a light emission driver EDC, and a data driver DDC.

The display panel DP may include scan lines GWL1 to GWLn, GCL1 to GCLn, GIL1 to GILn, GBL1 to GBLn, and GRL1 to GRLn, light emission lines EL1 to ELn, and data lines DL1 to DLm (where, ‘m’ and ‘n’ are integers greater than 1). The display panel DP may include multiple pixels connected to the scan lines GWL1 to GWLn, GCL1 to GCLn, GIL1 to GILn, GBL1 to GBLn, and GRL1 to GRLn, the light emission lines EL1 to ELn, and the data lines DL1 to DLm.

For example, a pixel PXij (where ‘i’ and ‘j’ are integers greater than 1) located on an i-th horizontal line (or an i-th pixel row) and a j-th perpendicular line (or a j-th pixel column) may be connected to an i-th first scan line GWLi, an i-th second scan line GCLi, an i-th third scan line GILi, an i-th fourth scan line GBLi, an i-th fifth scan line GRLi, a j-th data line DLj, and an i-th light emission line ELi.

The pixel PXij may include multiple transistors and multiple capacitors. The pixel PXij may be supplied with a first power voltage VDD (or first driving voltage), a second power voltage VSS (or second driving voltage), a third power voltage Vref (or reference voltage), a fourth power voltage Vint1 (or first initialization voltage), a fifth power voltage Vint2 (or second initialization voltage), and a sixth power voltage Vcomp (or compensation voltage).

The voltage values of the first power voltage VDD and the second power voltage VSS may be set such that current flows in the light emitting device. For example, the first power voltage VDD may be set to a higher voltage than the second power voltage VSS.

The third power voltage Vref may be a voltage for initializing a gate of a driving transistor included in the pixel PXij. The third power voltage Vref may be used to implement a predetermined or selected grayscale by using a voltage difference with a data signal. To this end, the third power voltage Vref may be set to a predetermined or selected voltage within the voltage range of the data signal.

In an embodiment, the third power voltage Vref may be set within about ±8V of the sixth power voltage Vcomp. In detail, the third power voltage Vref may be set to a numerical range from a potential less than the sixth power voltage Vcomp by about 8V to a potential greater than the sixth power voltage Vcomp by about 8V. However, this is illustratively described, and the third power voltage Vref is not limited to any one embodiment.

The fourth power voltage Vint1 may be a voltage for initializing a storage capacitor included in the pixel PXij. The fourth power voltage Vint1 may be set to a voltage lower than the third power voltage Vref. For example, the fourth power voltage Vint1 may be set to a voltage lower than a difference between the third power voltage Vref and a threshold voltage (Vth) of the driving transistor. For example, the fourth power voltage Vint1 may be set to about 4V or more and about 20V or less. In case that the fourth power voltage Vint1 is set to a potential of about 4V or more, characteristics of an N-type transistor may be easily overcome. However, the disclosure is not limited thereto.

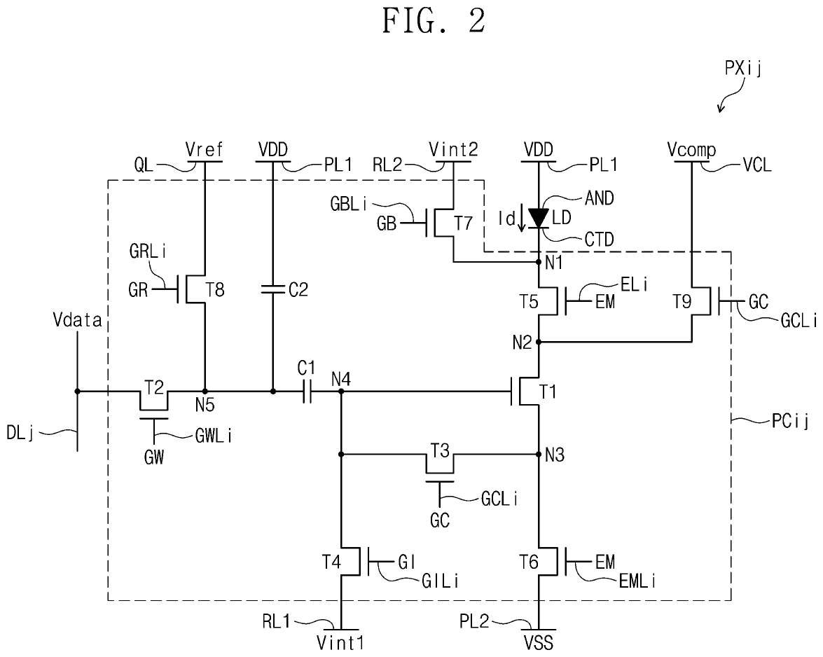

The fifth power voltage Vint2 may be set as a DC voltage. The fifth power voltage Vint2 may be a voltage for initializing a cathode of a light emitting device LD (refer to FIG. 2) included in the pixel PXij. The fifth power voltage Vint2 may be set to a voltage similar to or equal to the first power voltage VDD, but is not limited thereto.

The sixth power voltage Vcomp may allow a predetermined or selected current to be supplied to the driving transistor in case that a threshold voltage of the driving transistor is compensated. The sixth power voltage Vcomp may be set to a voltage less than the first power voltage VDD, but is not limited thereto, and the sixth power voltage Vcomp may be set to a voltage similar to or equal to the first power voltage VDD.

For example, the sixth power voltage Vcomp may be set to a voltage similar to or equal to the third power voltage Vref. In another embodiment, the sixth power voltage Vcomp may be set less than the fourth power voltage Vint1. However, this is illustratively described, and the sixth power voltage Vcomp is not limited to any one embodiment.

Although it is illustrated in FIG. 1 that all of the first to sixth power voltages VDD, VSS, Vref, Vint1, Vint2, and Vcomp are supplied from a power supplier PWS, the disclosure is not limited thereto. For example, the first power voltage VDD, the second power voltage VSS, and the sixth power voltage Vcomp may all be supplied regardless of the structure of the pixel PXij, and at least one of the third power voltage Vref, the fourth power voltage Vint1, and the fifth power voltage Vint2 may not be supplied corresponding to the structure of the pixel PXij.

In an embodiment of the disclosure, signal lines connected to the pixel PXij may be set in various ways corresponding to the circuit structure of the pixel PXij.

The scan driver SDC may receive a first control signal SCS from the timing controller TC, and may supply a scan signal to each of the first scan lines GWL1 to GWLn, the second scan lines GCL1 to GCLn, the third scan lines GIL1 to GILn, the fourth scan lines GBL1 to GBLn, and the fifth scan lines GRL1 to GRLn, based on the first control signal SCS.

The scan signal may be set to a gate-on voltage such that transistors receiving the scan signal may be turned on.

For example, a scan signal supplied to a P-channel metal oxide semiconductor (PMOS) transistor may be set to a logic low level, and a scan signal supplied to an N-channel metal oxide semiconductor (NMOS) transistor may be set to a logic high level. Hereinafter, the meaning of “a scan signal is supplied” may be understood as a scan signal supplied with a logic level that turns on a transistor controlled thereby.

In FIG. 1, for convenience of description, the scan driver SDC is illustrated as having a single configuration, but the disclosure is not limited thereto. According to embodiments, multiple scan drivers may be included to supply scan signals to each of the first scan lines GWL1 to GWLn, the second scan lines GCL1 to GCLn, the third scan lines GIL1 to GILn, the fourth scan lines GBL1 to GBLn, and the fifth scan lines GRL1 to GRLn.

The light emission driver EDC may supply a light emission signal to the light emission lines EL1 to ELn based on a second control signal ECS. For example, the light emission signal may be sequentially supplied to the light emission lines EL1 to ELn.

Transistors connected to the light emission lines EL1 to ELn of the disclosure may be formed of NMOS transistors. The light emission signal supplied to the light emission lines EL1 to ELn may be set to a gate-off voltage (e.g., a logic high level). Transistors receiving the light emission signal may be turned off in case that the light emission signal is supplied, and may be turned on in other cases.

The second control signal ECS may include a light emission start signal and clock signals, and the light emission driver EDC may be implemented with a shift register that may sequentially shift the light emission start signal of a pulse form using the clock signals to sequentially generate and output the light emission signal of a pulse form.

The data driver DDC may receive a third control signal DCS and image data RGB from the timing controller TC. The data driver DDC may convert the image data RGB of a digital form into an analog data signal (i.e., a data signal). The data driver DDC may supply the data signal to the data lines DL1 to DLm in response to the third control signal DCS.

The third control signal DCS may include a data enable signal that instructs output of a valid data signal, a horizontal start signal, and a data clock signal. For example, the data driver DDC may include a shift register that generates a sampling signal by shifting a horizontal start signal in synchronization with the data clock signal, a latch that latches the image data RGB in response to the sampling signal, a digital-to-analog converter (or decoder) that converts the latched image data RGB (e.g., data of a digital form) into data signals of an analog form, and buffers (or amplifiers) that output the data signals to the data lines DL1 to DLm.

The power supplier PWS may supply the first power voltage VDD, the second power voltage VSS, and the third power voltage Vref, which drive the pixel PXij to the display panel DP. The power supplier PWS may supply at least one of the fourth power voltage Vint1, the fifth power voltage Vint2, and the sixth power voltage Vcomp to the display panel DP.

For example, the power supplier PWS may supply the first power voltage VDD, the second power voltage VSS, the third power voltage Vref, the fourth power voltage Vint1, the fifth power voltage Vint2, and the sixth power voltage Vcomp to the display panel DP via a first power line PL1 (refer to FIG. 2), a second power line PL2 (refer to FIG. 2), a reference voltage line QL (refer to FIG. 2), a first initialization voltage line RL1 (refer to FIG. 2), a second initialization voltage line RL2 (refer to FIG. 2), and a compensation voltage line VCL (refer to FIG. 2), respectively.

The power supplier PWS may be implemented with a power management IC (PMIC), but is not limited thereto.

The timing controller TC may generate the first control signal SCS, the second control signal ECS, the third control signal DCS, and a fourth control signal PCS based on input image data IRGB, a sync signal Sync (e.g., a vertical sync signal, a horizontal sync signal, etc.), a data enable signal DE, a clock signal, etc. The first control signal SCS may be supplied to the scan driver SDC, the second control signal ECS may be supplied to the light emission driver EDC, the third control signal DCS may be supplied to the data driver DDC, and the fourth control signal PCS may be supplied to the power supplier PWS. The timing controller TC may rearrange the input image data IRGB according to the arrangement of the pixel PXij in the display panel DP to generate the image data RGB (or frame data).

At least one of the scan driver SDC, the light emission driver EDC, the data driver DDC, the power supplier PWS, and the timing controller TC may be formed in the display panel DP or may be implemented as an integrated circuit to be connected to the display panel DP. At least two of the scan driver SDC, light emission driver EDC, the data driver DDC, the power supplier PWS, and the timing controller TC may be implemented as a single integrated circuit. For example, the data driver DDC and the timing controller TC may be implemented as a single integrated circuit.

In the above, the display device DD according to an embodiment has been described with reference to FIG. 1, but the display device of the disclosure is not limited thereto. Additional signal lines may be added or omitted according to the configuration of pixels. A connection relationship between one pixel and signal lines may be changed. For example, in case that one of the signal lines is omitted, another signal line may replace the omitted signal line.

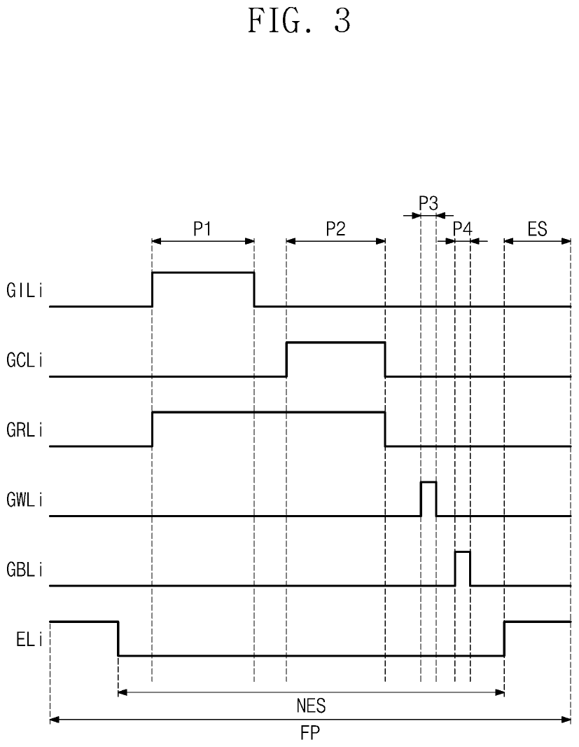

FIG. 2 is a schematic diagram of an equivalent circuit of a pixel PXij according to an embodiment of the disclosure. FIG. 3 is a schematic timing diagram for describing an operation of a display device DD, according to an embodiment of the disclosure. In FIG. 3, a timing diagram for driving the pixel PXij illustrated in FIG. 2 is illustrated as an example. Hereinafter, the disclosure will be described with reference to FIGS. 2 and 3.

FIG. 2 illustrates an equivalent circuit diagram of the pixel PXij connected to the i-th first scan line GWLi (hereinafter referred to as first scan line) and connected to a j-th data line DLj (hereinafter referred to as data line).

In an embodiment, the pixel PXij may include first to ninth transistors T1 to T9, a first capacitor C1, a second capacitor C2, and the light emitting device LD (or light emitting diode).

In an embodiment, each of the first to ninth transistors T1 to T9 may be an N-type transistor. The first transistor T1 implemented as an N-type may have an advantage in that a change in device characteristics or an instantaneous afterimage generation rate is small. However, the disclosure is not limited thereto, and among the first to ninth transistors T1 to T9, the first transistor T1 may be an N-type transistor, and each of the others may be implemented with either an N-type transistor or a P-type transistor.

In an embodiment, an anode AND of the light emitting device LD is connected to the first power line PL1 transferring the first power voltage VDD, and a cathode CTD of the light emitting device LD is connected to a pixel driver PCij through a first node N1. The light emitting device LD may generate light with luminance corresponding to the amount of current supplied from the first power line PL1 toward the first node N1.

The light emitting device LD may include a light emitting layer. The light emitting layer emits light by absorbing energy corresponding to a potential difference between the anode AND and the cathode CTD. The light emitting layer may be an organic layer or an inorganic layer. The light emitting layer may be a single layer or multiple layers, and may have a form connected in series or parallel between the anode AND and the cathode CTD. The light emitting device LD according to an embodiment of the disclosure may be provided in various forms as long as it can emit light, and is not limited to any one embodiment.

In an embodiment, the first transistor T1 may be a driving transistor.

A first electrode of the first transistor T1 may be connected to a second node N2 and a second electrode of the first transistor T1 may be connected to a third node N3. A gate of the first transistor T1 may be connected to a fourth node N4. The first transistor T1 may control a driving current Id flowing from the first power line PL1 transferring the first power voltage VDD to the second power line PL2 transferring the second power voltage VSS via the light emitting device LD in response to a voltage of the fourth node N4. The first power voltage VDD may be set to a voltage having a higher potential than the second power voltage VSS.

In this specification, “electrical connection between a transistor and a signal line or between a transistor and a transistor” means “that the source, drain, and gate of the transistor have an integral shape with the signal line or are connected through a connecting electrode.”

In an embodiment, the fifth transistor T5 may be disposed between the first electrode of the first transistor T1 and the light emitting device LD. The fifth transistor T5 may be referred to as the first emission control transistor. However, this is illustrated as an example, and the first electrode of the first transistor T1, that is, the second node N2 may be directly connected to the cathode CTD of the light emitting device LD, and the fifth transistor T5 may be omitted.

The second transistor T2 may be connected between the data line DLj and a fifth node N5. In detail, a first electrode of the second transistor T2 may be connected to the data line DLj transferring a data signal Vdata (hereinafter also referred to as a data voltage) and a second electrode of the second transistor T2 is connected to the fifth node N5. A gate of the second transistor T2 may receive a gate signal GW (hereinafter also referred to as a data write scan signal) through a first scan line GWLi. The second transistor T2 may be a switching transistor. The second transistor T2 may be turned on in case that the gate signal GW is supplied to the first scan line GWLi, and may electrically connect the data line DLj to the fifth node N5.

A first electrode of the third transistor T3 may be connected to the fourth node N4 and a second electrode of the third transistor T3 may be connected to the third node N3. A gate of the third transistor T3 may receive a compensation scan signal GC through the i-th second scan line GCLi (hereinafter referred to as the second scan line). The third transistor T3 may be turned on in case that the compensation scan signal GC is supplied to the second scan line GCLi, and may electrically connect the third node N3 to the fourth node N4. The third transistor T3 may reduce a leakage current of the pixel PXij.

The fourth transistor T4 may be connected between the fourth node N4 and a first initialization voltage line RL1. A first electrode of the fourth transistor T4 may be connected to the fourth node N4 and a second electrode of the fourth transistor T4 may be connected to the first initialization voltage line RL1 providing the first initialization voltage Vint1. A gate of the fourth transistor T4 may receive the initialization scan signal GI through the i-th third scan line GILi (hereinafter referred to as the third scan line). The fourth transistor T4 may be referred to as a first initialization transistor. The fourth transistor T4 may be turned on in case that the initialization scan signal GI is supplied to the third scan line GILi, and may supply the first initialization voltage Vint1 to the fourth node N4. A level of the first initialization voltage Vint1 may be about 4V to about 20V.

The fifth transistor T5 may be connected between the first transistor T1 and the light emitting device LD. In detail, a first electrode of the fifth transistor T5 may be connected to the cathode CTD of the light emitting device LD through the first node N1 and a second electrode of the fifth transistor T5 may be connected to the first electrode of the first transistor T1 through the second node N2. The fifth transistor T5 may receive the light emission signal EM through the i-th light emission line ELi (hereinafter referred to as light emission line). The fifth transistor T5 may be referred to as a first emission control transistor. In case that the light emission signal EM is supplied to the light emission line ELi, the fifth transistor T5 may be turned on and may electrically connect the light emitting device LD to the first transistor T1.

The sixth transistor T6 may be connected between the second power line PL2 and the third node N3. A first electrode of the sixth transistor T6 may be connected to the second electrode of the third transistor T3 and a second electrode of the sixth transistor T6 may receive the second power voltage VSS through the second power line PL2. A gate of the sixth transistor T6 may be electrically connected to the light emission line ELi. The sixth transistor T6 may be referred to as a second emission control transistor. In case that the light emission signal EM is supplied to the light emission line ELi, the sixth transistor T6 may be turned on and may electrically connect the second electrode of the first transistor T1 to the second power line PL2.

In an embodiment, the fifth transistor T5 and the sixth transistor T6 may be connected to the same light emission line ELi and may be simultaneously turned on through the same light emission signal EM. In case that the fifth transistor T5 and the sixth transistor T6 are turned on, a current path from the first power line PL1 to the second power line PL2 via the first transistor T1 may be formed. Accordingly, the driving current Id may flow through the light emitting device LD.

The seventh transistor T7 may be connected between the first node N1 and a second initialization voltage line RL2. A first electrode of the seventh transistor T7 may receive the second initialization voltage Vint2 through the second initialization voltage line RL2. A second electrode of the seventh transistor T7 may be connected to the cathode CTD of the light emitting device LD.

In one embodiment of the disclosure, a gate of the seventh transistor T7 may receive a black scan signal GB through the i-th fourth scan line GBLi (hereinafter referred to as the fourth scan line). The seventh transistor T7 may be referred to as a second initialization transistor. The seventh transistor T7 may be turned on in case that the black scan signal GB is supplied to the fourth scan line GBLi, and may provide the second initialization voltage Vint2 to the cathode CTD of the light emitting device LD. The seventh transistor T7 may reduce a leakage current of the pixel PXij.

The eighth transistor T8 may be connected between the fifth node N5 and a reference voltage line QL. A first electrode of the eighth transistor T8 may receive the reference voltage Vref through the reference voltage line QL, and a second electrode of the eighth transistor T8 may be connected to the fifth node N5. In an embodiment, a gate of the eighth transistor T8 may receive a reset scan signal GR through the i-th fifth scan line GRLi (hereinafter referred to as the fifth scan line). The eighth transistor T8 may be turned on in case that the reset scan signal GR is supplied to the fifth scan line GRLi, and may provide the reference voltage Vref to the fifth node N5.

The ninth transistor T9 may be connected between the compensation voltage line VCL and the second node N2. A first electrode of the ninth transistor T9 may receive the compensation voltage Vcomp through the compensation voltage line VCL, and a second electrode of the ninth transistor T9 may be connected to the second node N2 to be electrically connected to the first electrode of the first transistor T1. A gate of the ninth transistor T9 may receive the compensation scan signal GC through the second scan line GCLi. The ninth transistor T9 may be turned on in case that the compensation scan signal GC is supplied to the second scan line GCLi, and may provide the compensation voltage Vcomp to the first electrode of the first transistor T1. A level of the compensation voltage Vcomp may be less than that of the first initialization voltage Vint1. For example, the level of the compensation voltage Vcomp may be about 3.9V to about 19.9V. In an embodiment, a level of the reference voltage Vref may be equal to or greater than the compensation voltage Vcomp minus about 8V and may be equal to or less than the compensation voltage Vcomp plus about 8V. For example, the reference voltage Vref may satisfy an inequality of Vcomp −8V≤Vref≤Vcomp+8V.

In an embodiment, the gate of the ninth transistor T9 is illustrated connected to the same scan line GCLi as the gate of the third transistor T3. Accordingly, the ninth transistor T9 and the third transistor T3 may be simultaneously turned on through the same scan signal GC. However, this is illustrated as an example, and the ninth transistor T9 and the third transistor T3 may be driven through scan signals independent of each other, and are not limited to any one embodiment.

The first capacitor C1 may be disposed between the fourth node N4 and the fifth node N5. The first capacitor C1 may store charges corresponding to a voltage difference between the fourth node N4 and the fifth node N5. The first capacitor C1 may be referred to as a storage capacitor. A data voltage Vdata may be applied to the fourth node N4 through the first capacitor C1 in a coupling manner.

The second capacitor C2 may be connected to the fifth node N5. One electrode of the second capacitor C2 may be connected to the first power line PL1 receiving the first power voltage VDD, and the other electrode of the second capacitor C2 may be connected to the fifth node N5. The second capacitor C2 may store charges corresponding to a voltage difference (VDD−Vdata) between the first power voltage VDD and a voltage of the fifth node N5. The second capacitor C2 may be referred to as a hold capacitor. The second capacitor C2 may have a storage capacity greater than that of the first capacitor C1. For example, the second capacitor C2 may be set to have a capacitance smaller than about 10 times greater than that of the first capacitor C1. For example, the second capacitor C2 may be set to have about 3 to about 5 times greater capacitance than that of the first capacitor C1. The second capacitor C2 may minimize a voltage change of the fifth node N5 in response to a voltage change of the fourth node N4. Therefore, it is enough to drive light emitting device LD without big size of the capacitor C2 in this invention.

FIG. 3 illustratively illustrates a part of any one frame period FP, and the display device DD according to an embodiment of the disclosure displays an image for each frame period. During one frame period FP, each of the first scan lines GWL1 to GWLn, the second scan lines GCL1 to GCLn, the third scan lines GIL1 to GILn, the fourth scan lines GBL1 to GBLn, the fifth scan lines GRL1 to GRLn, and the light emission lines EL1 to ELn may be sequentially scanned. Hereinafter, referring to FIG. 3, driving of the pixel PXij illustrated in FIG. 2 will be described in detail.

Referring to FIG. 3, each of the scan signals GW, GC, GB, GI, and GR and the light emission signal EM may have a high level during a partial period and a low level during a partial period. The N-type transistors having gates electrically connected to the scan lines GWL1 to GWLn, GCL1 to GCLn, GBL1 to GBLn, GIL1 to GILn, and GRL1 to GRLn and the light emission line EL1 to ELn may be turned on in case that the corresponding signal has a high level. The P-type transistors having gates electrically connected to the scan lines GWL1 to GWLn, GCL1 to GCLn, GBL1 to GBLn, GIL1 to GILn, and GRL1 to GRLn and the light emission line EL1 to ELn may be turned on in case that the corresponding signal has a low level. In an embodiment, all of the first to ninth transistors T1 to T9 are described as N-type transistors.

Referring to FIG. 3, one frame period FP may include an emission period ES and a non-emission period NES. The non-emission period NES may be a period other than the emission period ES. The non-emission period NES may include a first period P1 as a first initialization period, a second period P2 as a compensation period, a third period P3 as a data writing period, and a fourth period P4 as a second initialization period.

The first period P1 may be a period in which the gate of the driving transistor T1 is initialized. The light emission signal of a gate-off voltage (e.g., a logic low level) may be supplied to the light emission line ELi from the first period P1 to the fourth period P4. In case that the light emission signal having the gate-off voltage is supplied to the light emission line ELi, the fifth transistor T5 and the sixth transistor T6 may be turned off. In case that the fifth transistor T5 and the sixth transistor T6 are turned off, a current path from the first power line PL1 to the second power line PL2 may be blocked, and accordingly, the light emitting device LD maintains a non-emission state. For example, during the non-emission period NES including the first period P1 to the fourth period P4, the light emitting device LD may be set to the non-emission state.

A scan signal may be supplied to each of the third scan line GILi and the fifth scan line GRLi during the first period P1.

In case that the initialization scan signal GI is supplied to the third scan line GILi and the fourth transistor T4 is turned on, the first initialization voltage Vint1 may be supplied to the fourth node N4 through the fourth transistor T4. Accordingly, the first transistor T1 may be initialized to the first initialization voltage Vint1 during the first period P1.

In case that the reset scan signal GR is supplied to the fifth scan line GRLi and the eighth transistor T8 is turned on, the reference voltage Vref may be supplied to the fifth node N5. Accordingly, the fifth node N5 may be initialized to the reference voltage Vref during the first period P1. Accordingly, the first period P1 may be an initialization period in which the fourth node N4 and the fifth node N5 are initialized to the first initialization voltage Vint1 and the reference voltage Vref, respectively. During the second period P2, scan signals may be supplied to each of the second scan line GCLi and the fifth scan line GRLi. The fifth scan line GRLi may actually maintain the supply of the scan signal supplied to the first period P1.

In case that the compensation scan signal GC is supplied to the second scan line GCLi, each of the third transistor T3 and the ninth transistor T9 may be turned on.

In case that the ninth transistor T9 is turned on, the compensation voltage Vcomp may be supplied to the second node N2. For example, the compensation voltage Vcomp may be directly applied to the first transistor T1.

The third transistor T3 may be turned on in the second period P2. The fourth transistor T4 turned on in the first period P1 may be turned off, and the eighth transistor T8 turned on in the first period P1 may maintain a turned-on state. Supply of the first initialization voltage Vint1 to the fourth node N4 may be stopped, and the fourth node N4 and the third node N3 may be connected through the third transistor T3. The fourth node N4 may correspond to the gate potential of the first transistor T1 and the third node N3 may correspond to the drain potential of the first transistor T1.

As the compensation voltage Vcomp is directly applied to the source of the first transistor T1 through the ninth transistor T9 during the second period P2, the gate potential of the first transistor T1 (or the fourth node N4) may correspond to a sum (Vcomp+Vth) of the compensation voltage Vcomp and the threshold voltage (Vth).

A potential difference may be generated between both ends of the first capacitor C1, so that the first capacitor C1 may store charges corresponding thereto. For example, during the second period P2, the first capacitor C1 may store charges corresponding to the voltage difference Vref−(Vcomp+Vth) between the fourth node N4 and the fifth node N5.

Subsequently, in case that a data write scan signal GW is supplied to the first scan line GWLi during the third period P3, the second transistor T2 may be turned on. The data voltage Vdata corresponding to data may be provided to the fifth node N5 through the second transistor T2.

As the eighth transistor T8 turned on in the second period P2 is turned off and the second transistor T2 is turned on, the data voltage Vdata may be provided to the fifth node N5. A potential of the fifth node N5 may be changed from the reference voltage Vref to the data voltage Vdata. For example, the voltage of the fifth node N5 may increase from the reference voltage Vref to the data voltage Vdata in response to a predetermined or selected gray level. In another embodiment, the voltage of the fifth node N5 may drop from the reference voltage Vref to the data voltage Vdata in response to the black gray level.

The first power voltage VDD and the data voltage Vdata may be applied to both ends of the second capacitor C2, and charges corresponding to a voltage difference VDD−Vdata between the two ends may be stored in the second capacitor C2.

As the third transistor T3 turned on during the second period P2 is turned off, the fourth node N4 may be set to a floating state. Since the voltage difference between the fourth node N4 and the fifth node N5 may be maintained uniformly by the first capacitor C1, the voltage of the gate (or the fourth node N4) of the first transistor T1 may be changed from the first voltage (V1) to the second voltage (V1+Δv). The first voltage (V1) may be a potential in the second period P2, and Δv may correspond to the changed voltage difference (Vdata−Vref) of the fifth node N5. For example, the voltage (V2) of the gate (or the fourth node N4) of the first transistor T1 in the third period P3 may correspond to Equation 1 below.

V2=V1+Δv=(Vcomp+Vth)+(Vdata+Vref) [Equation 1]

Subsequently, the black scan signal GB of the gate-on voltage (i.e., the logic high level) may be supplied to the fourth scan line GBLi during the fourth period P4. In case that the black scan signal GB is supplied, the seventh transistor T7 may be turned on, and the second initialization voltage Vint2 may be provided to the first node N1 through the seventh transistor T7. Accordingly, the cathode CTD of the light emitting device LD may be initialized to the second initialization voltage Vint2. During the non-emission period NES, the seventh transistor T7 may be turned on and driven only in the fourth period P4 after the turn-on driving of the third and ninth transistors T3 and T9 operating during the second period P2. The cathode CTD of the light emitting device LD may be initialized to the second initialization voltage Vint2 through the seventh transistor T7.

Subsequently, during the emission period ES, the light emission signal EM may be supplied to the light emission line ELi, and the fifth and sixth transistors T5 and T6 may be turned on. The remaining transistors T1 to T4 and T7 to T9 may be turned off. In case that the fifth transistor T5 is turned on, the first node N1 and the second node N2 may be electrically connected to each other. For example, in case that the fifth transistor T5 is turned on, the cathode CTD of the light emitting device LD and the first transistor T1 may be electrically connected to each other.

In case that the sixth transistor T6 is turned on, the second power line PL2 and the third node N3 may be electrically connected to each other. For example, in case that the sixth transistor T6 is turned on, the first transistor T1 may be electrically connected to the second power line PL2.

In case that the fifth transistor T5 and the sixth transistor T6 are turned on, a driving current Id may flow from the first power line PL1 to the second power line PL2 via the light emitting device LD, the fifth transistor T5, the driving transistor T1, and the sixth transistor T6. A current may be generated through the first transistor T1, and the driving current Id may flow to the light emitting device LD. The data signals output from the data driver DDC may be written in the display panel DP of the display device DD, and thus the light emitting device LD emits light. The driving current Id may be expressed by the following equations.

$$Id = \frac{1}{2} \cdot μ \cdot Cox \cdot \frac{W}{L} {( Vgs - Vth )}^{2} \qquad [ Equation 2 ]$$

$$Vgs = [ ( Vcomp + Vth ) + ( Vdata - Vref ) ] \qquad [ Equation 3 ]$$

$$Id = \frac{1}{2} \cdot μ \cdot Cox \cdot \frac{W}{L} {( Vcomp + Vdata - Vref )}^{2} \qquad [ Equation 4 ]$$

In the above equations, ‘μ’ and ‘Cox’ may be constants, ‘W’ may be a channel width of the first transistor T1, ‘L’ may be a channel length of the first transistor T1, and ‘Vgs’ may mean a differential voltage between the gate-source of the first transistor T1. Equation 4 may be a final result obtained by applying Equation 3 to Equation 2.

Referring to Equation 4, the driving current Id flowing through the light emitting device LD in the emission period ES may not be affected by the threshold voltage (Vth) of the first transistor T1. Therefore, according to the disclosure, a luminance of an image output from the display panel DP may be uniformly maintained regardless of the characteristics (e.g., threshold voltage (Vth)) of the first transistor T1.

Referring to Equation 4, the driving current Id may be affected by the compensation voltage Vcomp. In general, the driving current Id may appear as a value proportional to the compensation voltage Vcomp. The compensation voltage Vcomp may be directly applied to the first transistor T1 through the ninth transistor T9. Therefore, according to the disclosure, by further including the ninth transistor T9 in the pixel circuit PCij, it may be possible to directly compensate for the first transistor T1 by providing a compensation voltage Vcomp to the first transistor T1, and the driving current Id may be stably controlled.

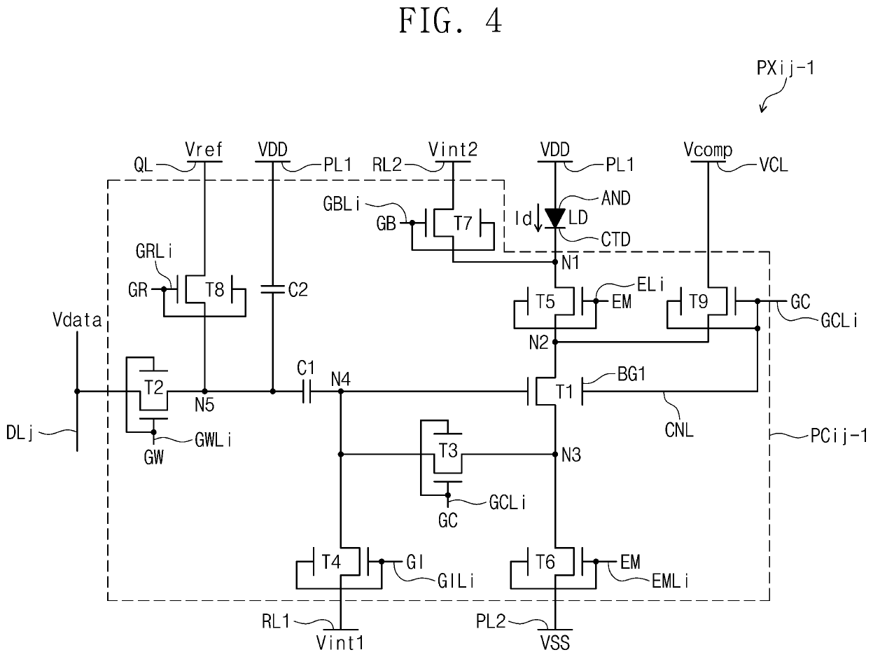

FIG. 4 is a schematic diagram of an equivalent circuit of a pixel PXij−1 according to an embodiment of the disclosure. A pixel circuit PCij−1 illustrated in FIG. 4 includes transistors actually corresponding to the pixel circuit PCij illustrated in FIG. 2 except that each of the transistors may have a dual-gate structure. For example, the pixel circuit PCij−1 illustrated in FIG. 4 may correspond to a case in which each of the transistors T1 to T9 constituting the pixel circuit PCij illustrated in FIG. 2 may be changed to a transistor having a structure including an upper gate and a bottom gate. The disclosure will be described with reference to FIG. 4 below.

As illustrated in FIG. 4, each of the first to ninth transistors T1 to T9 may include multiple gates. The first transistor T1 may have a structure different from that of the second to ninth transistors T2 to T9. In detail, each of the second to ninth transistors T2 to T9 may have a gate-synchronized structure. Accordingly, the upper gate and the bottom gate of each of the second to ninth transistors T2 to T9 may receive the same signal.

The upper gate and the bottom gate BG1 of the first transistor T1 may receive different signals. For example, the upper gate of the first transistor T1 may be connected to the fourth node N4 and the bottom gate BG1 of the first transistor T1 is connected to the gate of the ninth transistor T9 to be synchronized. Accordingly, the bottom gate BG1 of the first transistor T1 may receive a voltage at the same time that the ninth transistor T9 may be turned on.

In an embodiment, the bottom gate BG1 of the first transistor T1 and the second scan line GCLi may be connected through a separate connection line CNL in the non-display area. In an embodiment, the connection line CNL electrically connecting the bottom gate BG1 of the first transistor T1 and the second scan line GCLi may be separately provided as a connection line independent of connection lines connecting other transistors. However, this is illustrated as an example, and the connection line connecting the bottom gate BG1 of the first transistor T1 and the gate of the ninth transistor T9 may be disposed in the display area, and the bottom gate BG1 of the first transistor T1 and the gate of the ninth transistor T9 may be integrally formed and are not limited to any one embodiment.

In detail, the bottom gate BG1 of the first transistor T1 may receive the compensation scan signal GC through the i-th second scan line GCLi. The compensation voltage Vcomp may be applied to the source of the first transistor T1 in the second period P2 (refer to FIG. 3) in which the compensation scan signal GC of the gate-on voltage may be provided, and the compensation scan signal GC of the gate-on voltage may be applied to the bottom gate BG1 of the first transistor T1 and the upper and bottom gates of the third transistor T3. Accordingly, the compensation voltage Vcomp may be easily transferred to the fourth node N4 via the third node N3.

In an emission period ES (refer to FIG. 3) in which the compensation scan signal GC is not applied, a data swing range or a driving range may be expanded to improve grayscale expression.

According to the disclosure, by designing the first transistor T1 as a source-synchronized double gate structure, saturation of the output current may be achieved stably. Further, according to the disclosure, by designing each of the second to ninth transistors T2 to T9 as a gate-synchronized double-gate structure, in case turned on, current flows through each of the second to ninth transistors T2 to T9 may increase. Accordingly, as the area of the channel region required for each of the second to ninth transistors T2 to T9 may be reduced, the pixel circuit PCij−1 may be easily designed with a smaller area than that of the pixel circuit PCij illustrated in FIG. 2.

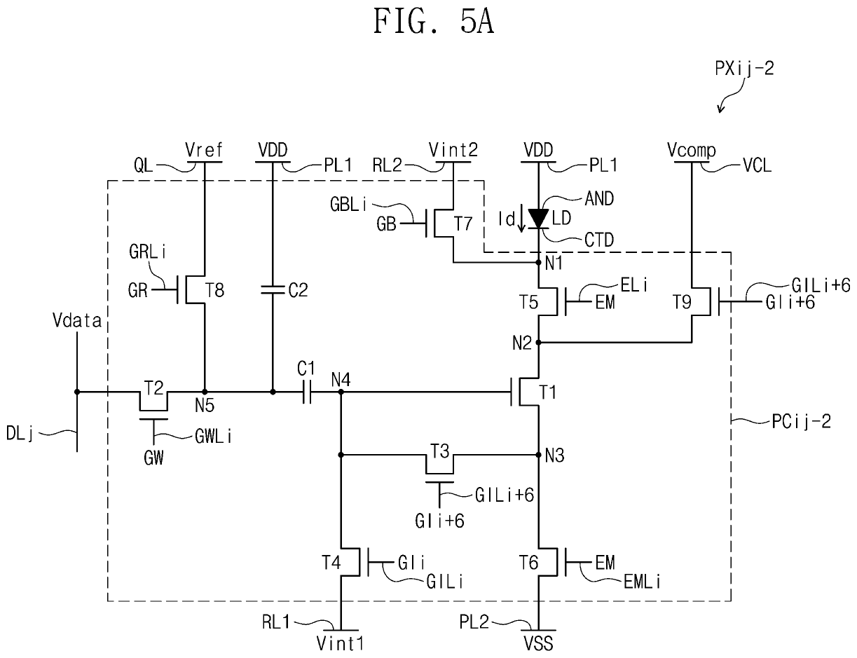

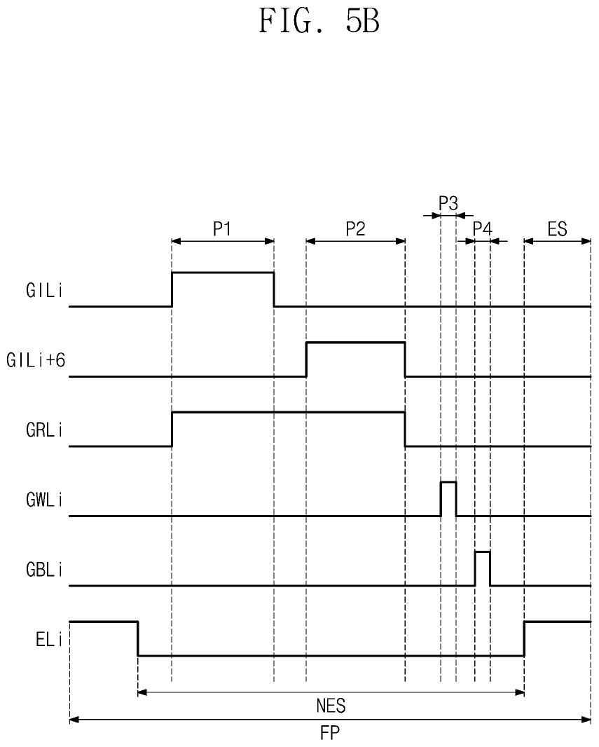

FIG. 5A is a schematic diagram of an equivalent circuit of a pixel PXij−2, according to an embodiment of the disclosure. FIG. 5B is a schematic timing diagram for describing an operation of FIG. 5A, according to an embodiment of the disclosure. FIG. 5A illustrates a pixel PXij−2 having a pixel circuit PCij−2 that includes transistors corresponding to the pixel circuit PCij illustrated in FIG. 2, but has a difference between connected signal lines. Hereinafter, the disclosure will be described with reference to FIGS. 5A and 5B. The same reference numerals are assigned to the same configurations as those described in FIGS. 1 to 4, and additional descriptions will be omitted to avoid redundancy.

As illustrated in FIG. 5A, each of the third transistor T3 and the ninth transistor T9 constituting the pixel circuit PCij−2 may be connected to an (i+6)-th third scan line GILi+6 (hereinafter referred to as an additional third scan line). Referring to FIG. 5B, an additional initialization scan signal GIi+6 (hereinafter referred to as the (i+6)-th initialization scan signal) of the gate-on voltage may be provided to the additional third scan line GILi+6 in the second period P2 in which the compensation voltage Vcomp is provided, and the third transistor T3 and the ninth transistor T9 may be turned on so that the above-described compensation operation may be performed.

The additional third scan line GILi+6 connected to the third and ninth transistors T3 and T9 may be set to the (i+6)-th third scan line GILi+6 such that timing does not overlap that of the third scan line GILi connected to the gate of the fourth transistor T4. However, this is illustratively described, and the additional third scan line GILi+6 connected to the third and ninth transistors T3 and T9 may be determined among third scan lines after the i-th corresponding to the third scan line GILi. For example, the additional third scan line GILi+6 connected to the third and ninth transistors T3 and T9 may be determined as (i+7)-th, (i+8)-th, etc. Therefore, the first period P1 for initialization and the second period P2 for compensation may not overlap each other.

According to the disclosure, the second scan line GCLi may be omitted compared to the pixel circuit PCij illustrated in FIG. 2. Accordingly, panel driving may be simplified.

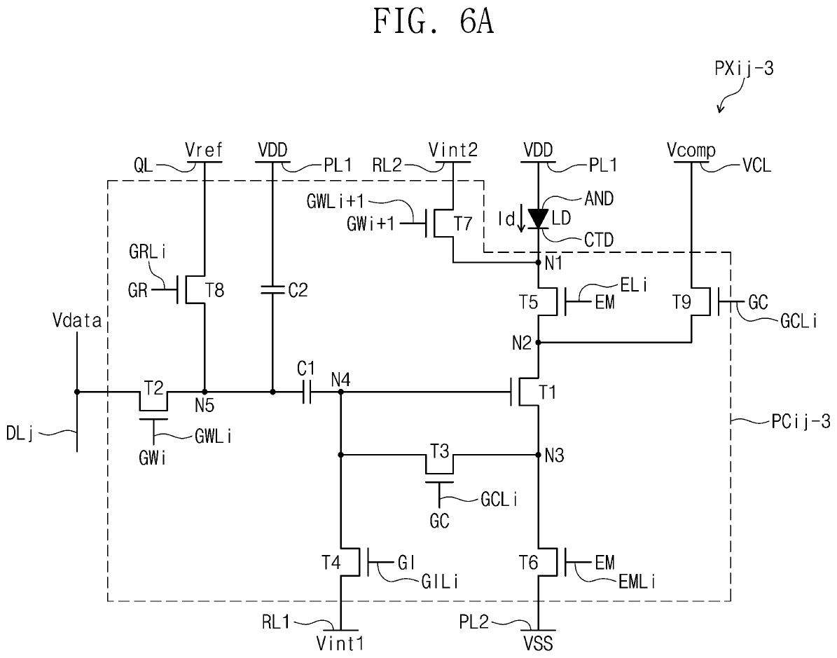

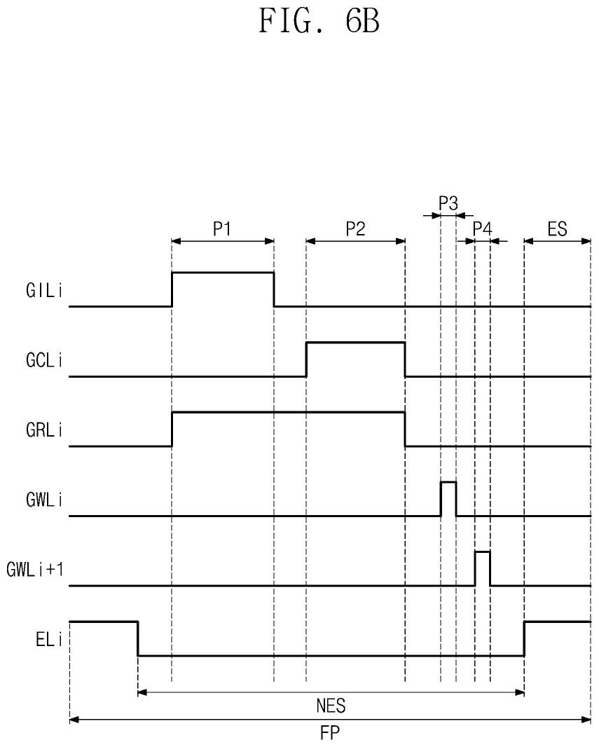

FIG. 6A is a schematic diagram of an equivalent circuit of a pixel PXij−3, according to an embodiment of the disclosure. FIG. 6B is a schematic timing diagram for describing an operation of FIG. 6A, according to an embodiment of the disclosure. FIG. 6A illustrates a pixel PXij−3 having a pixel circuit PCij−3 that includes transistors corresponding to the pixel circuit PCij illustrated in FIG. 2, but has a difference between connected signal lines. Hereinafter, the disclosure will be described with reference to FIGS. 6A and 6B. The same reference numerals are assigned to the same configurations as those described in FIGS. 1 to 4, and additional descriptions will be omitted to avoid redundancy.

Referring to FIG. 6A, the seventh transistor T7 constituting the pixel circuit PCij−3 may be connected to the (i+1)-th first scan line GWLi+1 (hereinafter referred to as an additional first scan line). Referring to FIG. 6B, in the fourth period P4 in which the second initialization voltage Vint2 is provided, an (i+1)-th data write scan signal GWi+1 of the gate-on voltage is provided to the additional first scan line GWLi+1 and the seventh transistor T7 is turned on so that the aforementioned cathode CTD initialization operation may be performed.

The additional first scan line GWLi+1 connected to the seventh transistor T7 may be set to the (i+1)-th first scan line GWLi+1 such that timing does not overlap that of the first scan line GWLi connected to the gate of the second transistor T2. However, this is illustratively described, and the additional first scan line GWLi+1 connected to the seventh transistor T7 may be determined among first scan lines after the i-th corresponding to the first scan line GWLi. For example, the additional first scan line GWLi+1 connected to the seventh transistor T7 may be determined as (i+3)-th, (i+5)-th, etc. Accordingly, the third period P3 for writing data and the fourth period P4 for second initialization may not overlap each other.

According to the disclosure, since the seventh transistor T7 is turned on by the additional first scan line GWLi+1, separate signal lines for driving the seventh transistor T7 present in each pixel may be omitted. For example, in the pixel circuit PCij−3, the fourth scan line GBLi (refer to FIG. 2) may be omitted compared to the pixel circuit PCij illustrated in FIG. 2, so that the configuration of the pixel circuit PCij−3 or the configuration of the scan driver SDC (refer to FIG. 1) for driving the panel may be simplified compared to the pixel circuit PCij illustrated in FIG. 2.

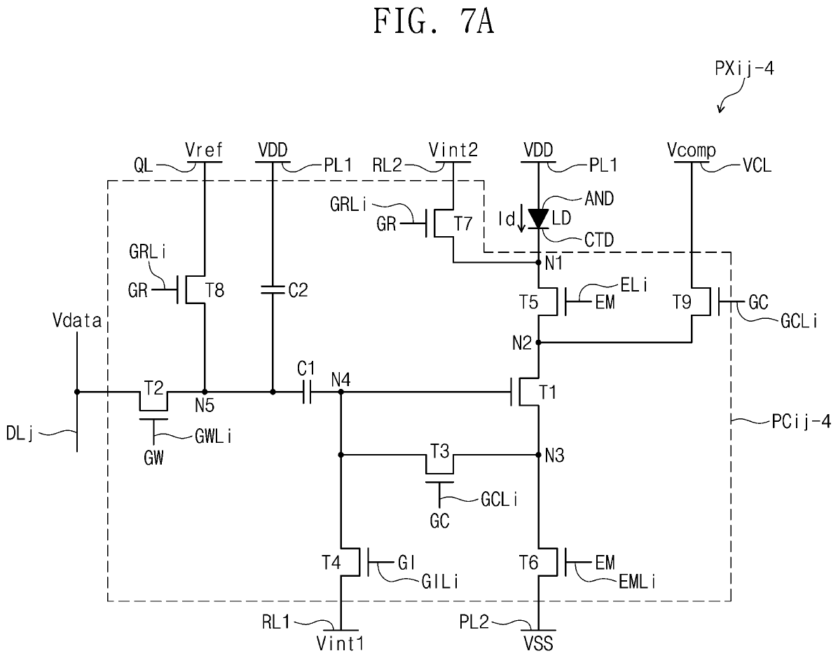

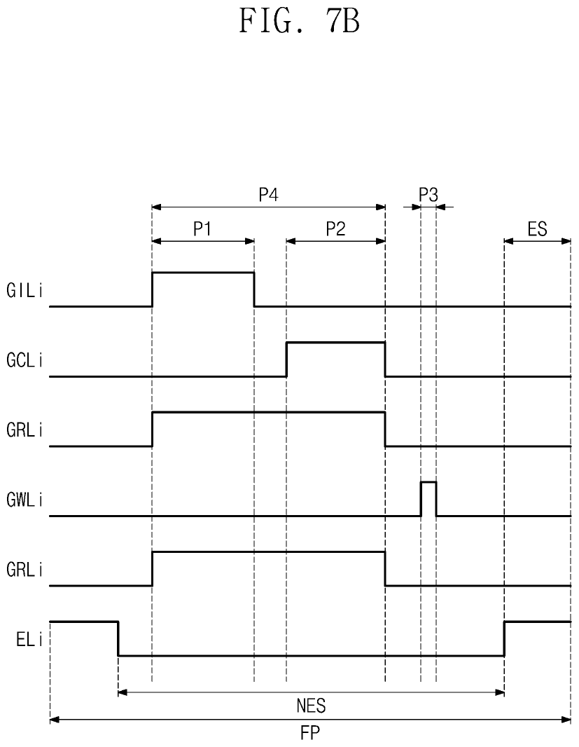

FIG. 7A is a schematic diagram of an equivalent circuit of a pixel PXij−4, according to an embodiment of the disclosure. FIG. 7B is a schematic timing diagram for describing an operation of FIG. 7A, according to an embodiment of the disclosure. FIG. 7A illustrates a pixel PXij−4 having a pixel circuit PCij−4 that includes transistors corresponding to the pixel circuit PCij illustrated in FIG. 2, but has a difference between connected signal lines. Below, the disclosure will be described with reference to FIGS. 7A and 7B. The same reference numerals are assigned to the same configurations as those described in FIGS. 1 to 4, and additional descriptions will be omitted to avoid redundancy.

Referring to FIG. 7A, the seventh transistor T7 constituting the pixel circuit PCij−4 may be connected to the fifth scan line GRLi. For example, the seventh transistor T7 may be turned on by the same scan signal as the eighth transistor T8.

Referring to FIG. 7B, during the first period P1 and the second period P2 in which the reset scan signal GR, which is the gate-on voltage, is applied to the fifth scan line GRLi, as described above, the eighth transistor T8 may maintain the turned-on state. The seventh transistor T7 also may maintains the turned-on state by the same signal. Accordingly, the fourth period P4 for initializing the cathode may overlap the first period P1 and the second period P2. For example, the cathode initialization operation may be simultaneously performed during the initialization period and compensation period.

According to the disclosure, the cathode initialization operation may be performed prior to the third period P3 in which data is written, and may be performed during a relatively long time period including the first period P1 and the second period P2. Therefore, the cathode initialization operation may be performed stably. According to the disclosure, a signal line for turning on the seventh transistor T7 and the eighth transistor T8 may be integrated into the fifth scan line GRLi. Therefore, the fourth scan line GBLi (refer to FIG. 2) may be omitted compared to the pixel circuit PCij illustrated in FIG. 2, and thus the configuration of the pixel circuit PCij−4 or the configuration of the scan driver SDC (refer to FIG. 1) for driving the panel may be simplified.

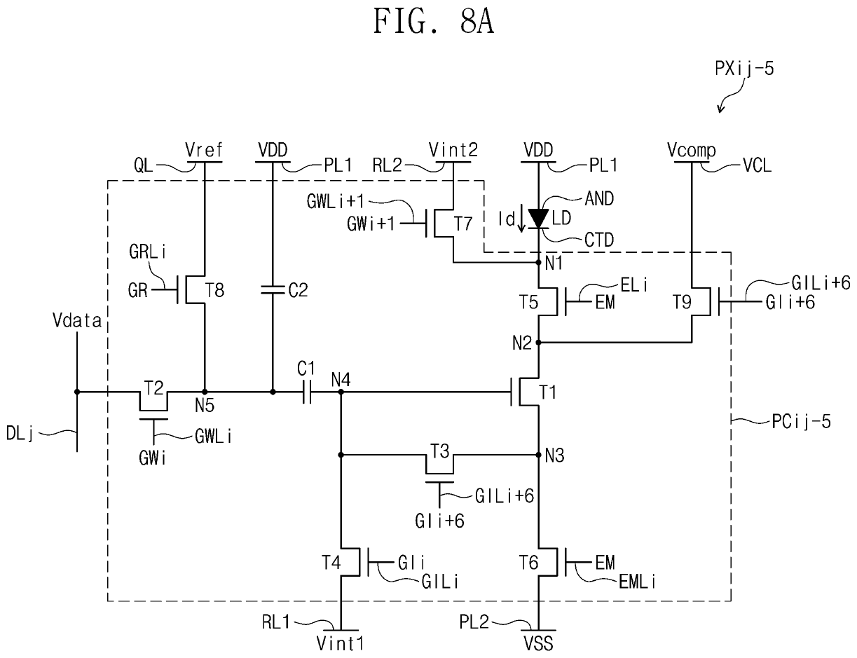

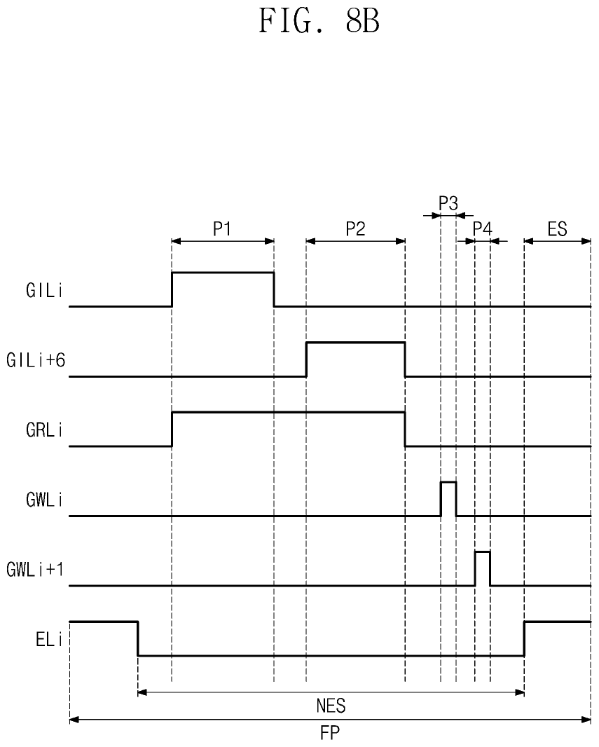

FIG. 8A is a schematic diagram of an equivalent circuit of a pixel PXij−5, according to an embodiment of the disclosure. FIG. 8B is a schematic timing diagram for describing an operation of FIG. 8A, according to an embodiment of the disclosure. FIG. 8A illustrates a pixel PXij−5 having a pixel circuit PCij−5 that includes transistors corresponding to the pixel circuit PCij illustrated in FIG. 2, but has a difference between connected signal lines. Below, the disclosure will be described with reference to FIGS. 8A and 8B. The same reference numerals are assigned to the same configurations as those described in FIGS. 1 to 4, and additional descriptions will be omitted to avoid redundancy.

Referring to FIGS. 8A and 8B, the seventh transistor T7 constituting the pixel circuit PCij−5 may be connected to the (i+1)-th first scan line GWLi+1 (hereinafter referred to as the additional first scan line). This may be a connection structure corresponding to the seventh transistor T7 illustrated in FIG. 6A. For example, as the (i+1)-th data write scan signal GWi+1 of the gate-on voltage is provided to the additional first scan line GWLi+1, the fourth period P4 in which the second initialization voltage Vint2 is provided may proceed. The seventh transistor T7 may be turned on by the (i+1)-th data write scan signal GWi+1, and thus the aforementioned cathode initialization operation may be performed.

Each of the third transistor T3 and the ninth transistor T9 constituting the pixel circuit PCij−5 may be connected to the (i+6)-th third scan line GILi+6 (hereinafter referred to as an additional third scan line). This may be a connection structure corresponding to the third and ninth transistors T3 and T9 illustrated in FIG. 5A. For example, as the (i+6)-th initialization scan signal GIi+6 of the gate-on voltage is provided to the additional third scan line GILi+6, the second period P2 in which the compensation voltage Vcomp is provided may proceed. The third transistor T3 and the ninth transistor T9 may be turned on by the (i+6)-th initialization scan signal GIi+6, and the above-described compensation operation may be performed.

The additional first scan line GWLi+1 connected to the seventh transistor T7 may be set to the (i+1)-th first scan line GWLi+1 such that timing does not overlap that of the first scan line GWLi connected to the gate of the second transistor T2. However, this is illustratively described, and the additional first scan line GWLi+1 connected to the seventh transistor T7 may be determined among first scan lines after the i-th corresponding to the first scan line GWLi, that is, the (i+1)-th or more first scan lines. For example, the additional first scan line GWLi+1 connected to the seventh transistor T7 may be determined as (i+3)-th, (i+5)-th, etc. Accordingly, the third period P3 for writing data and the fourth period P4 for second initialization may not overlap each other.

As in the above description, the additional third scan line GILi+6 connected to the third and ninth transistors T3 and T9 may be set to the (i+6)-th third scan line GILi+6 such that timing does not overlap that of the third scan line GILi connected to the gate of the fourth transistor T4. However, this is illustratively described, and the additional third scan line GILi+6 connected to the third and ninth transistors T3 and T9 may be determined among third scan lines after the i-th corresponding to the third scan line GILi. For example, the additional third scan lines GILi+6 connected to the third and ninth transistors T3 and T9 may be determined as (i+6)-th or more, for example, (i+7)-th, (i+8)-th, etc. Therefore, the first period P1 for initialization and the second period P2 for compensation may not overlap each other.

According to the disclosure, signal lines for driving the pixel circuit PCij−5 may be simplified into the two first scan lines GWLi and GWLi+1 having different timings, the two third scan lines GILi and GILi+6 having different timings, the fifth scan line GRLi, and the light emission line ELi. For example, the pixel circuit PCij−5 may be driven with four different signal lines. Therefore, compared to the pixel circuit PCij illustrated in FIG. 2, the second scan line GCLi (refer to FIG. 2) and the fourth scan line GBLi (refer to FIG. 2) may be omitted, so that the configuration of the pixel circuit PCij−5 or the configuration of the scan driver SDC (refer to FIG. 1) for driving the panel may be simplified.

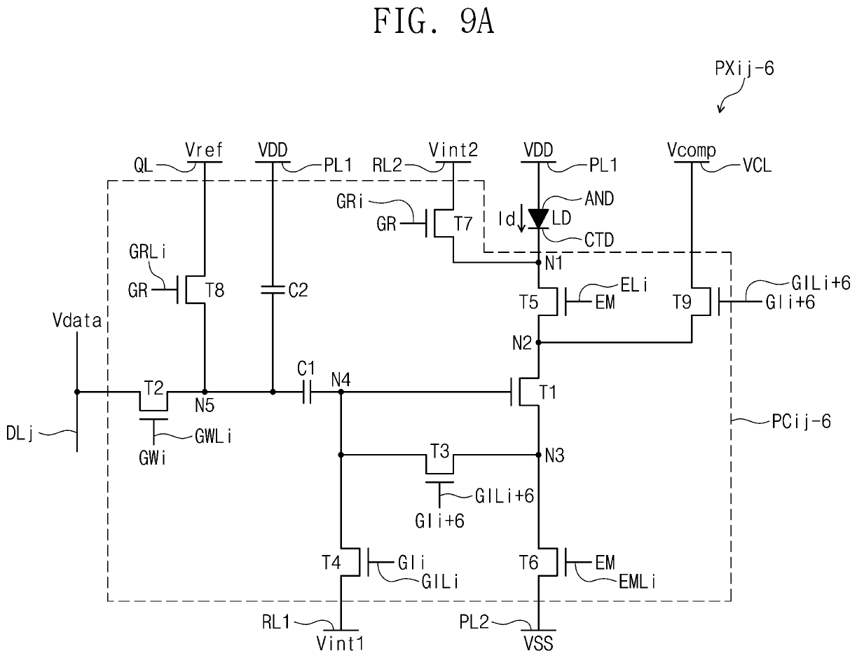

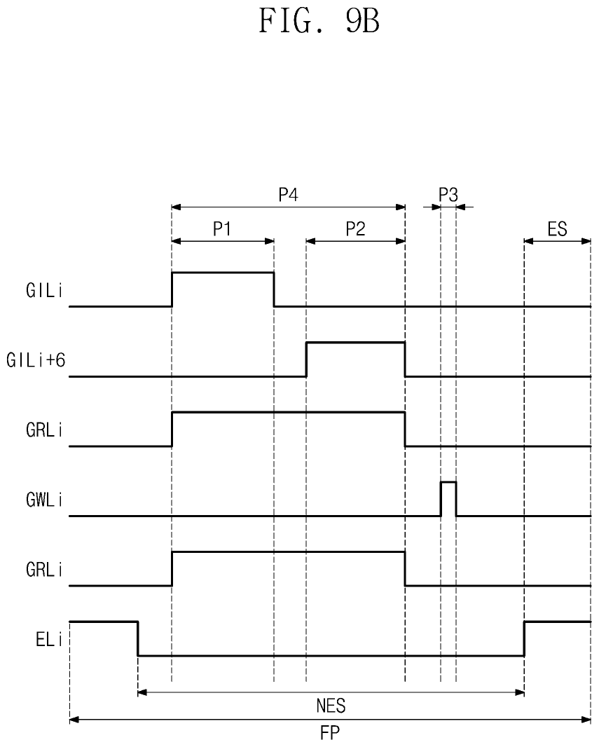

FIG. 9A is a schematic diagram of an equivalent circuit of a pixel PXij−6, according to an embodiment of the disclosure. FIG. 9B is a schematic timing diagram for describing an operation of FIG. 9A, according to an embodiment of the disclosure.

Referring to FIGS. 9A and 9B, the seventh transistor T7 constituting the pixel circuit PCij−6 may be connected to the fifth scan line GRLi. This may be a connection structure corresponding to the seventh transistor T7 illustrated in FIG. 7A. For example, the seventh transistor T7 may be turned on by the same scan signal as the eighth transistor T8. For example, the cathode initialization operation may be simultaneously performed during the initialization period and compensation period. Additional descriptions thereof will be omitted to avoid redundancy.

Each of the third transistor T3 and the ninth transistor T9 constituting the pixel circuit PCij−6 may be connected to the (i+6)-th third scan line GILi+6 (hereinafter referred to as an additional third scan line). This may be a connection structure corresponding to the third and ninth transistors T3 and T9 illustrated in FIG. 5A. For example, as the (i+6)-th initialization scan signal GIi+6 of the gate-on voltage is provided to the additional third scan line GILi+6, the second period P2 in which the compensation voltage Vcomp is provided may proceed. The third transistor T3 and the ninth transistor T9 may be turned on by the (i+6)-th initialization scan signal GIi+6, and the above-described compensation operation may be performed. Additional descriptions thereof will be omitted to avoid redundancy.

According to the disclosure, the signal lines for driving the pixel circuit PCij−6 may be simplified into the first scan line GWLi, the two third scan lines GILi and GILi+6 having different timings, the fifth scan line GRLi, and the light emission line ELi. For example, the pixel circuit PCij−6 may be driven with four different signal lines. Therefore, compared to the pixel circuit PCij illustrated in FIG. 2, the second scan line GCLi (refer to FIG. 2) and the fourth scan line GBLi (refer to FIG. 2) may be omitted, so that the configuration of the pixel circuit PCij−6 or the configuration of the scan driver SDC (refer to FIG. 1) for driving the panel may be simplified.

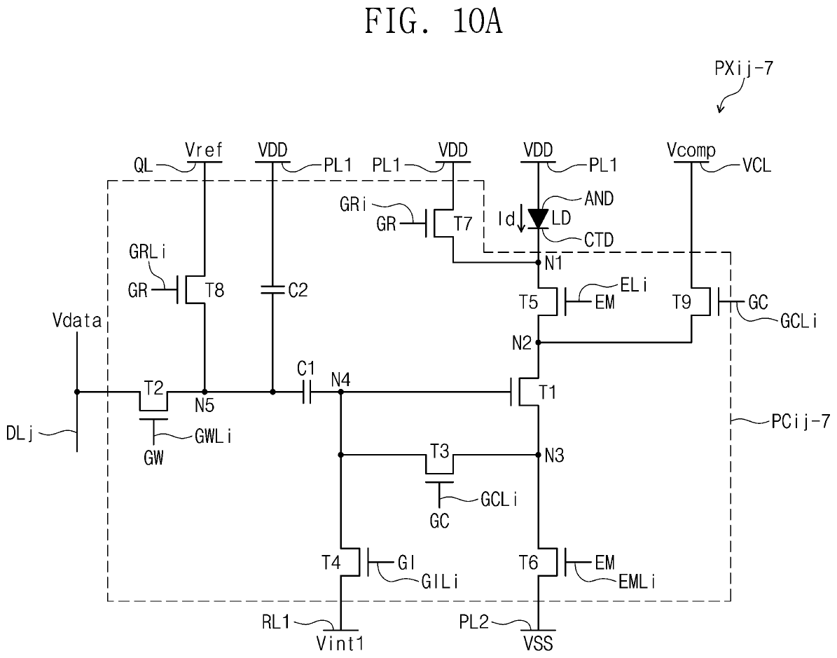

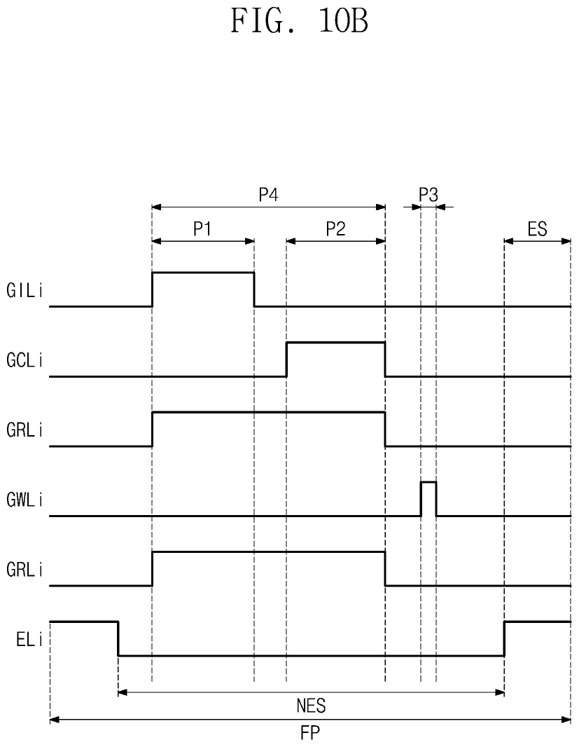

FIG. 10A is a schematic diagram of an equivalent circuit of a pixel PXij−7, according to an embodiment of the disclosure. FIG. 10B is a schematic timing diagram for describing an operation of FIG. 10A, according to an embodiment of the disclosure.

Referring to FIGS. 10A and 10B, the seventh transistor T7 constituting the pixel circuit PCij−7 may be connected to the fifth scan line GRLi. This may be a connection structure corresponding to the seventh transistor T7 illustrated in FIG. 7A. For example, the seventh transistor T7 may be turned on by the same scan signal as the eighth transistor T8. For example, the cathode initialization operation may be simultaneously performed during the initialization period and compensation period. Additional descriptions thereof will be omitted to avoid redundancy.

The seventh transistor T7 may be connected to the first power line PL1. The seventh transistor T7 may be turned on in case that the reset scan voltage GR is applied to the fifth scan line GRLi, and provides the first power voltage VDD to the first node N1. Accordingly, the cathode CTD of the light emitting device LD may be initialized to the first power voltage VDD during the fourth period P4.

According to the disclosure, in the pixel circuit PCij−7, the fourth period P4 for initializing the cathode may exist before the third period P3 for writing data. The cathode initialization may be performed during a period including the first period P1 for initializing the gate of the driving transistor T1 and the second period P2 for compensating for the threshold voltage of the driving transistor T1. Therefore, the cathode initialization operation may be performed stably.

According to an embodiment of the disclosure, the display device may prevent afterimages by including an NMOS inverted light emitting device, and may improve resolution by including a pixel in which the compensation voltage is independently applied directly to a driving transistor.

Embodiments have been disclosed herein, and although terms are employed, they are used and are to be interpreted in a generic and descriptive sense only and not for purpose of limitation. In some instances, as would be apparent by one of ordinary skill in the art, features, characteristics, and/or elements described in connection with an embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the disclosure.

What is claimed is:

1. A display device, comprising:
a display panel including a pixel; and
a panel driver that drives the display panel, wherein
the pixel includes:
a light emitting device electrically connected to a first power line;
a first transistor electrically connected to a cathode of the light emitting device and operating depending on a potential of a first node;
a second transistor electrically connected between a data line and a second node;
a third transistor electrically connected between a reference voltage line and the second node;
a first capacitor electrically connected between the first node and the second node;
a second capacitor electrically connected between a third node disposed between the first capacitor and the second node and the first power line; and
a fourth transistor electrically connected between the first transistor and a compensation voltage line.

2. The display device of claim 1, wherein the first power line is directly connected to an anode of the light emitting device.

3. The display device of claim 1, wherein the first transistor is an N-type transistor.

4. The display device of claim 1, wherein
the first transistor includes:
a first electrode electrically connected to the light emitting device;
a second electrode electrically connected to a second power line; and
a gate electrically connected to the first node, and
the fourth transistor is electrically connected to the first electrode.

5. The display device of claim 4, wherein the fourth transistor includes:
a first electrode electrically connected to the compensation voltage line;
a gate electrically connected to a compensation scan line; and
a second electrode electrically connected to the first electrode of the first transistor.

6. The display device of claim 4, wherein the pixel further includes:
a first emission control transistor electrically connected between the first electrode and the cathode of the light emitting device; and
a second emission control transistor electrically connected between the second electrode and the second power line.

7. The display device of claim 6, wherein the pixel further includes:
a first initialization transistor electrically connected between a first initialization voltage line and the first node; and
a second initialization transistor electrically connected between a first electrode of the first emission control transistor and a second initialization voltage line.

8. The display device of claim 7, wherein the pixel further includes a fifth transistor electrically connected between the second electrode of the first transistor and the first node.

9. The display device of claim 8, wherein a gate of the fifth transistor is electrically connected to a same compensation scan line as a gate of the fourth transistor.

10. The display device of claim 7, wherein
the first initialization voltage line provides a first initialization voltage, and
a magnitude of the first initialization voltage is in a range from about 4V to about 20V.

11. The display device of claim 10, wherein
the compensation voltage line provides a compensation voltage, and
a magnitude of the compensation voltage is less than that of the first initialization voltage.

12. The display device of claim 11, wherein
the reference voltage line provides a reference voltage, and
the reference voltage is equal to or greater than the compensation voltage minus about 8V and equal to or less than the compensation voltage plus about 8V.

13. The display device of claim 5, wherein
the first transistor further includes a back gate, and
the back gate is electrically connected to the compensation scan line electrically connected to the fourth transistor.

14. The display device of claim 1, wherein the panel driver includes:
a scan driver that outputs a plurality of scan signals to a plurality of scan lines; and
a data driver that outputs a data signal to the data line.

15. The display device of claim 6, wherein the pixel further includes:
a first initialization transistor electrically connected between a first initialization voltage line and the first node; and
a second initialization transistor electrically connected between a first electrode of the first emission control transistor and the first power line.

16. The display device of claim 1, wherein a data writing period in which the second transistor is turned on and a compensation period in which the fourth transistor is turned on do not overlap each other.

17. The display device of claim 16, wherein
the compensation period appears before the data writing period, and
the fourth transistor is turned off during the data writing period.

18. A display device, comprising:
a display panel including a pixel; and
a panel driver that drives the display panel, and including a scan driver electrically connected to a plurality of scan lines, wherein
the pixel includes:
a light emitting device including:
an anode electrically connected to a power line; and
a cathode electrically connected to a first transistor operating depending on a potential of a first node;
a second transistor electrically connected between a data line and the first node;
a first capacitor electrically connected between the second transistor and the first node; and
an additional transistor electrically connected between the first transistor and a compensation voltage line to directly apply a compensation voltage to the first transistor.

19. The display device of claim 18, wherein
the additional transistor is turned on depending on a compensation scan signal applied from the scan driver, and
the second transistor is turned on depending on a data writing scan signal applied from the scan driver.

20. The display device of claim 18, wherein the additional transistor is turned on before the second transistor and is turned off during a period in which the second transistor is turned on.
